(19) United States
(12) Patent Application Publication
(10) Pub. No.: US 2007/0294590 A1
(43) Pub. Date: Dec. 20, 2007

(54) COMPRESSION SCHEME TO REDUCE THE BANDWIDTH REQUIREMENTS FOR CONTINUOUS TRACE STREAM ENCODING OF SYSTEM PERFORMANCE

(75) Inventors: Manisha Agarwala, Richardson, TX (US); John M. Johnsen, Richardson, TX (US); Lewis Nardini, Richardson, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/383,697

(22) Filed: May 16, 2006

(51) Int. Cl. G06F 11/00

(52) U.S. Cl. 714/45

(57) ABSTRACT

A system and method of counting event patterns in order to reduce the bandwidth of event data sent to a monitoring computer. The event patterns are output as one or more data packets indicating the event pattern and a number of occurrences of the pattern.

### CROSS-REFERENCE TO RELATED APPLICATIONS

This application also may contain subject matter that may relate to the following commonly assigned co-pending applications incorporated herein by reference: “Scheme for Improving Bandwidth by Identifying Specific Fixed Pattern Sequences as Header Encoding Followed by the Pattern Count,” Ser. No. ______, filed May 16, 2006, Attorney Docket No. TI-37865 (1962-38000).

### BACKGROUND

Integrated circuits are ubiquitous in society and can be found in a wide array of electronic products. Regardless of the type of electronic product, most consumers have come to expect greater functionality when each successive generation of electronic products are made available because successive generations of integrated circuits offer greater functionality such as faster memory or microprocessor speed. Moreover, successive generations of integrated circuits that are capable of offering greater functionality are often available relatively quickly. For example, Moore's law, which is based on empirical observations, predicts that the speed of these integrated circuits doubles every eighteen months. As a result, integrated circuits with faster microprocessors and memory are often available for use in the latest electronic products every eighteen months.

Although successive generations of integrated circuits with greater functionality and features may be available every eighteen months, this does not mean that they can then be quickly incorporated into the latest electronic products. In fact, one major hurdle in bringing electronic products to market is ensuring that the integrated circuits, with their increased features and functionality, perform as desired. Generally speaking, ensuring that the integrated circuits will perform their intended functions when incorporated into an electronic product is called “debugging” the electronic product. Also, determining the performance, resource utilization, and execution of the integrated circuit is often referred to as “profiling”. Profiling is used to modify code execution on the integrated circuit so as to change the behavior of the integrated circuit as desired. The amount of time that debugging and profiling takes varies based on the complexity of the electronic product. One risk associated with the process of debugging and profiling is that it delays the product from being introduced into the market.

To prevent delaying the electronic product because of delay from debugging and profiling the integrated circuits, software based simulators that model the behavior of the integrated circuit are often developed so that debugging and profiling can begin before the integrated circuit is actually available. While these simulators may have been adequate in debugging and profiling previous generations of integrated circuits, such simulators are increasingly unable to accurately model the intricacies of newer generations of integrated circuits. Further, attempting to develop a more complex simulator that copes with the intricacies of integrated circuits with cache memory takes time and is usually not an option because of the preferred short time-to-market of electronic products. Unfortunately, a simulator's inability to effectively model integrated circuits results in the integrated circuits being employed in the electronic products without being debugged and profiled fully to make the integrated circuit behave as desired.

### SUMMARY

Disclosed herein is a system and method of counting event patterns in order to reduce the bandwidth of event data sent to a monitoring computer. The event patterns are output as one or more data packets indicating the event pattern and a number of occurrences of the pattern.

### BRIEF DESCRIPTION OF THE DRAWINGS

For a detailed description of exemplary embodiments of the invention, reference will now be made to the accompanying drawings in which:

FIG. 1 depicts an exemplary debugging and profiling system;

FIG. 2 depicts an embodiment of circuitry where code is being debugged and profiled using a trace;

FIG. 3 depicts an embodiment of circuitry where code is being debugged and profiled using a trace and a compression element;

FIG. 4 depicts an exemplary output data format;

FIG. 5 depicts another exemplary output data format with a pattern and a count value being output in two different data packets; and

FIG. 6 depicts another exemplary output data format with a pattern and a count value being output in the same data packet.

### DETAILED DESCRIPTION

FIG. 1 depicts an exemplary debugging and profiling system 100 including a host computer 105 coupled to a target device 110 through a connection 115. A user may debug and profile the operation of the target device 110 by operating the host computer 105. The target device 110 may be debugged and profiled in order for the operation of the target device 110 to perform as desired (for example, in an optimal manner) with circuitry 145. To this end, the host computer 105 may include an input device 120, such as a keyboard or mouse, as well as an output device 125, such as a monitor or printer. Both the input device 120 and the output device 125 couple to a central processing unit 130 (CPU) that is capable of receiving commands from a user and executing software 135 accordingly. Software 135 interacts with the target 110 and may allow the debugging and profiling of applications that are being executed on the target 110. In particular, software 135 may receive packets of data from the circuitry 145 and the target 110 corresponding to events occurring as a result of applications being executed on the target 110 by circuitry 145. Software 135 may be stored in a memory, such as a RAM, hard drive, etc., on computer 105.

Connection 115 couples the host computer 105 and the target device 110 and may be a wireless, hard-wired, or optical connection. Interfaces 140A and 140B may be used to interpret data from or communicate data to connection 115 respectively according to any suitable data communication method. Connection 150 provides outputs from the circuitry 145 to interface 140B. As such, software 135 on host computer 105 communicates instructions to be implemented by circuitry 145 through interfaces 140A and 140B across connection 115. The results of how circuitry 145 implements the instructions is output through connection 150 and communicated back to host computer 105. These results are analyzed on host computer 105 and the instructions are modified so as to debug and profile applications to be executed on target 110 by circuitry 145.

Connection 150 may be a wireless, hard-wired, or optical connection. In the case of a hard-wired connection, connection 150 is preferably implemented in accordance with any suitable protocol such as a Joint Testing Action Group (JTAG) type of connection. Additionally, hard-wired connections may include a real time data exchange (RTDX) type of connection developed by Texas instruments, Inc. Briefly put, RTDX gives system developers continuous real-time visibility into the applications that are being implemented on the circuitry 145 instead of having to force the application to stop, via a breakpoint, in order to see the details of the application implementation. Both the circuitry 145 and the interface 140B may include interfacing circuitry to facilitate the implementation of JTAG, RTDX, or other interfacing standards.

The target 110 preferably includes the circuitry 145 executing code that is actively being debugged and profiled. In some embodiments, the target 110 may be a test fixture that accommodates the circuitry 145 when code being executed by the circuitry 145 is being debugged and profiled. The debugging and profiling may be completed prior to widespread deployment of the circuitry 145. For example, if the circuitry 145 is eventually used in cell phones, then the executable code may be designed using the target 110.

The circuitry 145 may include a single integrated circuit or multiple integrated circuits that will be implemented as part of an electronic device. For example, the circuitry 145 may include multi-chip modules comprising multiple separate integrated circuits that are encapsulated within the same packaging. Regardless of whether the circuitry 145 is implemented as a single-chip or multiple-chip module, the circuitry 145 may eventually be incorporated into an electronic device such as a cellular telephone, a portable gaming console, network routing equipment, etc.

Debugging and profiling the executable firmware code on the target 110 using breakpoints to see the details of the code execution is an intrusive process and affects the operation and performance of the code being executed on circuitry 145. As such, a true understanding of the operation and performance of the code execution on circuitry 145 is not gained through the use of breakpoints.

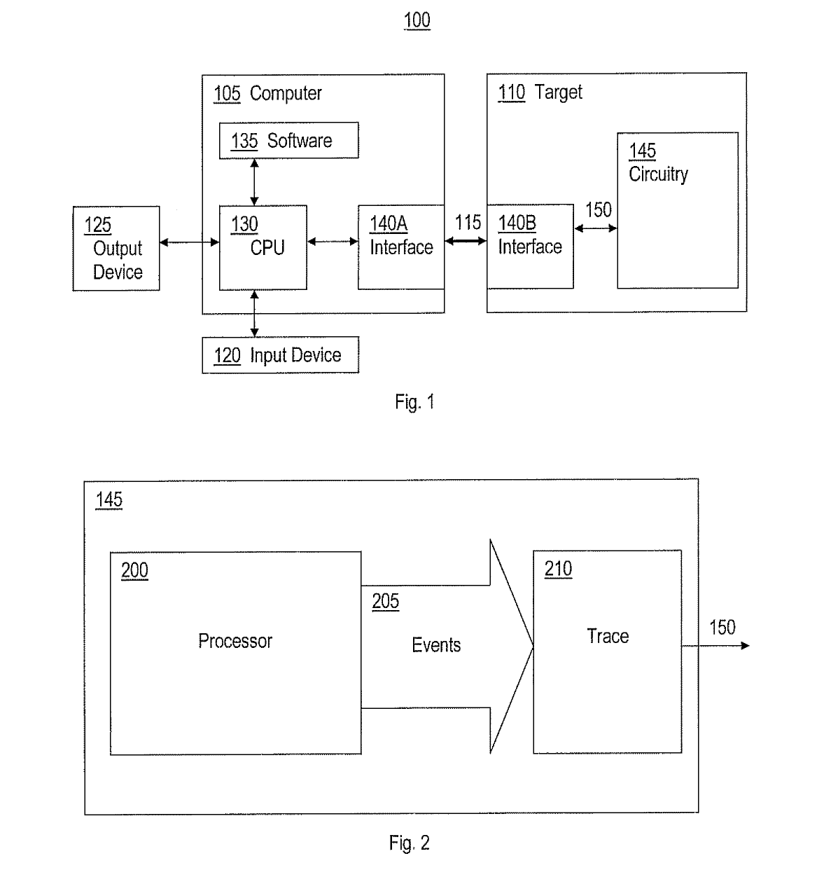

FIG. 2 depicts an embodiment of circuitry 145 where code is being debugged and profiled using a trace on circuitry 145 to monitor events. Circuitry 145 includes a processor 200 which executes the code. Through the operation of the processor 200 many events 205 may occur that are significant for debugging and profiling the code being executed by the processor 200. The term “events” or “event data” herein is being used broadly to describe any type of stall, in which processor 200 is forced to wait before it can complete executing an instruction, such as a CPU stall or cache stall; any type of memory event, such as a read hit or read miss; and any other occurrences which may be useful for debugging and profiling the code being executed on circuitry 145. The trace 210 monitors the desired events 205 and outputs the event data through connection 150 to computer 105. This enables a user of the computer 105 to see how the execution of the code is being implemented on circuitry 145. As successive generations of processors are developed with faster speeds, the number of events occurring on a processor such as processor 200 similarly increases, however, the bandwidth between computer 105 and circuitry 145 through connection 150 is limited. The amount of event data 205 recorded using a trace may exceed the bandwidth of connection 150. As such, intelligent ways of reducing the amount of event data without loosing any or much information are desirable.

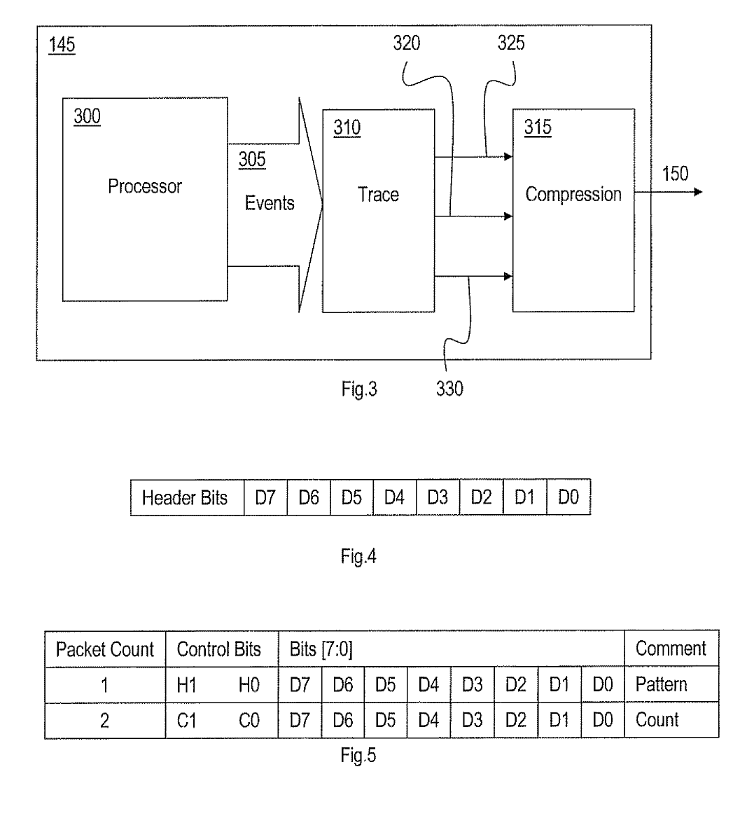

FIG. 3 discloses another embodiment of circuitry 145 where code is being debugged and profiled using a trace on circuitry 145 to monitor events. Circuitry 145 includes a processor core 300 which executes the code. Through the operation of the processor 300 many events 305 may occur that are significant for debugging and profiling the code being executed by the processor 200. Those events are monitored by a trace 310 which outputs various event streams such as a PC event stream 320, a timing event stream 325, and a data event stream 330. The event streams are input to a compression block 315 which compresses the event data and sends the event data to computer 105 through connection 150. Software 135 may then decompress the event data in order to interpret the events.

Table 1 is an exemplary table of the outputs on the various event streams 320-330, for a given trace interval:

TABLE 1

| Timing Stream | PC stream | Data Stream |
|---|---|---|
| Timing Sync Point, | Pc Sync Point, id = 1 | Data Sync Point, id = 1 |
| id = 1 | | |
| Timing Data | | |
| | PC Data | Memory Data |
| Timing Data | | Memory Data |
| Timing Data | PC Data | Memory Data |
| | PC Data | |
| Timing Data | | Memory Data |
| Timing Sync Point, | Pc Sync Point, id = 2 | Data Sync Point, id = 2 |
| id = 2 | | |

As shown in Table 1 event data may occur simultaneously across the various event streams. For example, on the first line of the table a Sync Point with an id=1 may indicate that each of the streams is synchronized to each other and mark the start of a trace interval. On the other hand, on the last line of the table a Sync Point with an id=2 may indicate that each of the streams is synchronized to each other and mark the end of a trace interval. Note that the event data, such as the timing, PC, or memory data, may also occur simultaneously across the various event streams. In this case a priority may be given such that each event data is output in a given order.

Each event data shown in Table 1 may be represented by a data packet. FIG. 4 depicts an exemplary event data packet. In this example the event data packet is 10 bits with the first two bits being a header indicating the type of event data that is being represented, such as a PC data, timing data, or memory data. The following eight bits are data bits with each bit representing a clock cycle of the processor 300. A “0” may indicate that no event occurred on that clock cycle, and a “1” may indicate that an event has occurred on that clock cycle. As such, an exemplary output from the processor 300 may appear as follows:
11101110 11101110 11101110 11101110 11101110 11101110 11101110 11101110

### Using the event data packet format shown in FIG. 4 the event data shown above may be output in eight event data packets as shown in Table 2.

TABLE 2

| Packet Count | Header Bits | D7 | D6 | D5 | D4 | D3 | D2 | D1 | D0 |
|---|---|---|---|---|---|---|---|---|---|
| 1 | H1 H0 | 1 | 1 | 1 | 0 | 1 | 1 | 1 | 0 |
| 2 | H1 H0 | 1 | 1 | 1 | 0 | 1 | 1 | 1 | 0 |
| 3 | H1 H0 | 1 | 1 | 1 | 0 | 1 | 1 | 1 | 0 |
| 4 | H1 H0 | 1 | 1 | 1 | 0 | 1 | 1 | 1 | 0 |
| 5 | H1 H0 | 1 | 1 | 1 | 0 | 1 | 1 | 1 | 0 |
| 6 | H1 H0 | 1 | 1 | 1 | 0 | 1 | 1 | 1 | 0 |
| 7 | H1 H0 | 1 | 1 | 1 | 0 | 1 | 1 | 1 | 0 |
| 8 | H1 H0 | 1 | 1 | 1 | 0 | 1 | 1 | 1 | 0 |

As discussed above, there is a limited bandwidth between the trace 310 and the computer 105. As shown in table 2 through the execution of code by processor 300, each command tends to have a characteristic execution pattern which in turn produces a characteristic event pattern. For example, the execution of the code may utilize system memory to produce a stall pattern associated with memory misses and conflicts. By counting the number of occurrences of one or more event patterns the event data may be output in a compressed format. By compressing the event data more events, or a greater frequency of events, may be monitored by the trace and still sent to a computer 105 to be interpreted.

FIG. 5 depicts an improved format for the event data packet. As shown in FIG. 5 the event data packet would comprise two or more packets of data. The first packet identified by the two header bits H1 and H0 would indicate the pattern that is being counted in bits D7-D0. The second packet identified by the two header bits C1 and C0 would indicate a number of times the pattern has occurred. Note that a plurality of the count packets may be used to extend the count range beyond 2⁷. In particular, for each successive count packet identified by the two header bits C1 and C0 the count range would increase by eight more bits. In the example used above, the event data output from the processor 300 using the event data packet of FIG. 5 as shown below in Table 3:

TABLE 3

| Packet Count | Header Bits | D7 | D6 | D5 | D4 | D3 | D2 | D1 | D0 |
|---|---|---|---|---|---|---|---|---|---|
| 1 | H1 H0 | 1 | 1 | 1 | 0 | 1 | 1 | 1 | 0 |
| 2 | C1 C0 | 0 | 0 | 0 | 0 | 1 | 0 | 0 | 0 |

As shown in Table 3, the eight event data packets needed to represent the event data from processor 300 using the format of FIG. 4 can be reduced to only two data packets using the format of FIG. 5. This effect can be further magnified by noting that using the format of FIG. 4, if the pattern were repeated up to 2⁷ times then 2⁷ packets would need to be used to represent the event data. However, using the format of FIG. 5 only two event data packets would need to be used to represent the event data. It is noted that while the pattern and the count value in the above example were sent in two different event data packets, they could be included in the same event data packet.

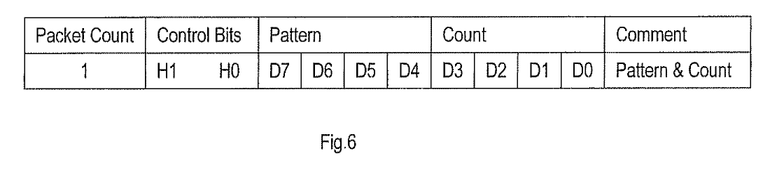

FIG. 6 depicts an example of an event data packet where both the pattern that is being counted and the count value indicating the number of times that pattern has occurred are in the data packet. As shown in FIG. 6, there are two header bits H1 and H0 similar to the previous examples. The next four data bits indicate the pattern that is being counted, and the last four data bits indicate the number of times that pattern has occurred. As such, an exemplary output from the processor 300 may appear as follows:
11101110 11101110 11101110 1110

### Using this example, the output from processor 300 may be sent to computer 105 in just one packet as shown in Table 4.

TABLE 4

| Packet Count | Header Bits | D7 | D6 | D5 | D4 | D3 | D2 | D1 | D0 |
|---|---|---|---|---|---|---|---|---|---|
| 1 | H1 H0 | 1 | 1 | 1 | 0 | 0 | 1 | 1 | 1 |

As shown in Table 4 a pattern of “1110” corresponding to bits D7-D4 is being counted. In the example output of processor 300 there are seven iterations of that pattern. As such a binary count value of “0111” is counted in bits D3-D0 for the count value. If the count range is not sufficient then, as was the case in the example of FIG. 5, a plurality of the count packets may be used to extend the count range beyond 2³. In particular, for each successive packet identified by the two header bits C1 and C0 the count range would increase by eight more bits. For example, if one additional count packet was padded on to the event data packet of FIG. 6 then a total count range of 2¹¹ would be possible. It is noted that while the bits were evenly split between the pattern and the count value, any allocation of bits may be used. For example, two pattern bits and six count bits. While the example of FIG. 6 shows that a shorter pattern may be counted, it is noted that the pattern may also be extended to be longer than eight bits. In this case the header may need to three bits. Further, use of any of the formats discussed above may be programmably selected. For example, computer 105 may control the compression element to select between various packet formats. In this case, the computer 105 would need to communicate to the compression element 315 the current packet format.

As such the trace compression element 315 may be configured to detect and count patterns in order to compress the amount of event data that needs to be output to computer 105. The data output to computer 105 may be output in one or more data packets that indicate a pattern and a count value of the number of times that pattern has occurred. Software 135 may decode the data packets in order to determine the pattern of events and number of times it has occurred. It is noted that compression element 315 may also further compress the event data using know bit reduction methods such as Huffman coding.

While various system and method embodiments have been shown and described herein, it should be understood that the disclosed systems and methods may be embodied in many other specific forms without departing from the spirit or scope of the invention. The present examples are to be considered as illustrative and not restrictive. The intention is not to be limited to the details given herein, but may be modified within the scope of the appended claims along with their full scope of equivalents.

1. A method comprising:
executing a series of instruction on a processor;
monitoring a stream of events corresponding to said executing step;
determining a pattern of said events;
counting a number of occurrences of said pattern;
outputting one or more data packets indicating said pattern and said number.

2. The method of claim 1, wherein:
said outputting step outputs two or more of said data packets wherein one or more first data packets indicate said pattern and one or more second data packets indicate said count value.

3. The method of claim 2, wherein:
said first data packets comprise bits for a header indicating a type of said events and bits for said pattern.

4. The method of claim 3, wherein:
said second data packets comprises bits for a header indicating a count packet and bits for said number.

5. The method of claim 2, wherein:
said first data packet is only one data packet which comprises bits for a header indicating a type of said events, bits for said pattern, and bits for said number.

6. The method of claim 5, wherein:
said second data packets comprises bits for a header indicating a count packet and bits for said number.

7. The method of claim 1, wherein:
said outputting step outputs one data packet indicating both said pattern and said number.

8. The method of claim 7, wherein:
said one data packet comprises bits for a header indicating a type of said events, bits for said pattern, and bits for said number.

9. The method of claim 1, further comprising:
programmably selecting how many will be output and the format of said data packets.

10. A system comprising:
a processor configured to execute a series of instruction;
a trace configured to monitor a stream of events from said processor corresponding to the execution of said instructions; and
a compression element configured to determining a pattern of said events and count a number of occurrences of said pattern;
wherein said compression element outputs one or more data packets indicating said pattern and said number.

11. The system of claim 10, wherein:
said compression element outputs two or more of said data packets wherein one or more first data packet indicate said pattern and one or more second data packets indicate said count value.

12. The system of claim 11, wherein:
said first data packets comprise bits for a header indicating a type of said events and bits for said pattern.

13. The system of claim 12, wherein:
said second data packets comprise bits for a header indicating a count packet and bits for said number.

14. The system of claim 11, wherein:
said first data packet is only one data packet which comprises bits for a header indicating a type of said events, bits for said pattern, and bits for said number.

15. The system of claim 14, wherein:
said second data packets comprises bits for a header indicating a count packet and bits for said number.

16. The system of claim 10, wherein:
said compression element outputs one data packet indicating both said pattern and said number.

17. The system of claim 16, wherein:
said one data packet comprises bits for a header indicating a type of said events, bits for said pattern, and bits for said number.

18. The system of claim 10, wherein:
said compression element may be progammably configured to selecting how many will be output and the format of said data packets.

19. A storage medium containing software that, when executed by a processor, causes the processor to:
receive one or more packets from a target circuit;
parse said packets to extract a bit pattern and a count of occurrences of said bit pattern;
wherein said packets encode information pertaining to events occurring on said target circuit.

20. The software of claim 19, wherein:
two or more of said packets are received; and
one or more first packets of said one or more packets indicate said pattern and one or more second packets of said one or more packets indicate said count value.

21. The software of claim 20, wherein:
said first packets comprise bits for a header indicating a type of said events and bits for said pattern.

22. The software of claim 21, wherein:
said second packets comprises bits for a header indicating a count packet and bits for said count.

23. The software of claim 20, wherein:
said first packet is only one packet which comprises bits for a header indicating a type of said events, bits for said pattern, and bits for said count.

24. The software of claim 23, wherein:
said second packets comprise bits for a header indicating a count packet and bits for said count.

25. The software of claim 19, wherein:
one packet is received indicating both said pattern and said count.

26. The software of claim 25, wherein:
said one packet comprises bits for a header indicating a type of said events, bits for said pattern, and bits for said count.

27. The storage medium of claim 19 containing software that, when executed by a processor, further causes the processor to:
programmably select how many will be output and the format of said data packets.
